(19) United States
(12) Patent Application Publication
(10) Pub. No.: US 2004/0115554 A1
(43) Pub. Date: Jun. 17, 2004

(54) Coated carrier particles

(75) Inventor: Ronald E. Godlove, Bergen, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation.

(21) Appl. No.: 10/320,816

(22) Filed: Dec. 16, 2002

(51) Int. Cl. G03G 9/113

(52) U.S. Cl. 430/111.35; 430/111.1; 399/273

(57) ABSTRACT

A development system having a magnetic developer material that features novel coated carrier particles. In embodiments of the invention, the coated carrier particles incorporate a coating of sufficiently resilient characteristic so as to maintain the encapsulation of the respective carrier core while withstanding the mechanical action of a development material stripping device which would otherwise cause fragmentation of the carrier particles. Preferably, the carrier coating is of a sufficiently thick and/or a resilient nature such that the desired encapsulation is maintained.

This invention relates generally to an electrophotographic printing machine and, more particularly, to a development system employing developer material having coated carrier particles therein for development of electrostatic images.

An electrophotographic printing machine includes a photoconductive member which is charged to a substantially uniform potential to sensitize the surface thereof. The charged portion of the photoconductive member is exposed to an optical light pattern representing the document being produced. This records an electrostatic image on the photoconductive member corresponding to the informational areas contained within the document. After the electrostatic image is formed on the photoconductive member, the image is developed by bringing a developer material into effective contact therewith. Typically, the developer material comprises toner particles bearing electrostatic charges chosen to cause them to move toward and adhere to the desired portions of the electrostatic image. The resulting physical image is subsequently transferred to a copy sheet. Finally, the copy sheet is heated or otherwise processed to permanently affix the powder image thereto in the desired image-wise configuration.

Development may be interactive or non-interactive depending on whether toner already on the image may or may not be disturbed or removed by subsequent development procedures. Sometimes the terms scavenging and non-scavenging are used interchangeably with the terms interactive and non-interactive. Non-interactive development is most useful in color systems when a given color toner must be deposited on an electrostatic image without disturbing previously applied toner deposits of a different color, or cross-contaminating the color toner supplies.

In the prior art, both interactive and non-interactive development have been accomplished with magnetic brushes. In typical interactive embodiments, the magnetic brush is in the form of a rigid cylindrical sleeve which rotates around a fixed assembly of permanent magnets. In this type development system, the cylindrical sleeve is usually made of an electrically conductive, non-ferrous material such as aluminum or stainless steel, with its outer surface textured to improve developer adhesion. The rotation of the sleeve transports magnetically adhered developer through the development zone where there is direct contact between the developer brush and the imaged surface, and toner is stripped from the passing magnetic brush filaments by the electrostatic fields of the image.

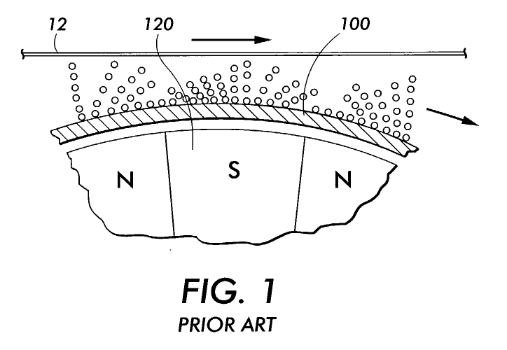

The conventional magnetic developer roll for such a magnetic brush development method consists of a plurality of magnets which are formed on a cylindrical magnetic core piece. The magnets are tightly arranged in parallel with the central longitudinal axis of the magnetic core piece. However, as illustrated in FIG. 1, it may be observed that the use of bead chains according to the prior art will result in linear ridges, or “piles”, of developer material on the developer sleeve 100 due to the high density of bead chains approximately at the midpoint of each magnet 120. (Corresponding valleys, or “troughs”, of developer material thus locate at the intersections of adjacent magnets 120.) As a consequence of this effect, the resulting developer chains accumulate over the circumference of the developer roll in linear piles having varying peaks and troughs that are arranged in parallel to the central longitudinal axis of the magnetic developer roll.

In typical practice, the magnetic developer roll is operated with associated devices, such as a skiving blade, that engage the developer sleeve 100 in order to remove unused developer and toner material from the developer sleeve 100. Similar devices may be located adjacent the developer sleeve to meter fresh developer material onto the developer sleeve 100 so as to effect replenishment of fresh developer material. In typical practice, such blades are oriented in parallel with the same central longitudinal axis of the magnetic developer roll.

For example, U.S. Pat. No. 5,409,791 to Kaukeinen et al., the disclosure of which is hereby incorporated by reference, describes a non-interactive magnetic brush development method employing permanently magnetized carrier beads operating with a rotating multipole magnet within a conductive and nonmagnetic sleeve. Magnetic field lines form arches in the space above the sleeve surface and form chains of carrier beads. The developer chains are held in contact with the sleeve and out of direct contact with the photoreceptor by gradients provided by the multipole magnet. As the core rotates in one direction relative to the sleeve, the magnetic field lines beyond the sleeve surface rotate in the opposite sense, moving chains in a tumbling action which transports developer material along the sleeve surface. The strong mechanical agitation effectively dislodges toner particles generating a rich powder cloud which can be developed to the adjacent photoreceptor surface under the influence of development fields between the sleeve and the electrostatic image. However, such circumferential flow of developer material occurs over full surface of the sleeve; hence, a developer material stripping device such as a skiving blade must be included for removing spent developer before it returns to the development zone.

In conceiving the present invention, I have found that the above-described development systems suffer from the following undesirable phenomena.

Relative rotation of the magnetic developer roll and the developer sleeve will rotate successive ones of the magnets within the developer sleeve and thus under the engaging edge of the skiving blade. A corresponding movement of successive linear piles of developer material move along the exterior of the developer sleeve. As a result, the skiving blade will periodically impact the entire length of a linear pile of developer material, whereupon the development system undergoes a periodic and substantial increase in mechanical stress, due to the rapid succession of developer pile masses encountered by the edge of the skiving blade. During each stress peak, the skiving blade, magnetic developer roll, developer material, along with the motor drive and any respective mechanisms including motor drive bearings, will experience a significant increase in mechanical force. Such skiving action can also include vibration between both the skiving blade and the shell, with resulting impact to the carrier particles, which shortens developer material life. For example, with respect to developer material containing carrier particles each of which are formed of a carrier core and a coating, the entire coating may separate from the carrier core as fragments in the form of chips or flakes, or the particles may fracture or otherwise fail upon impact, with subsequent sub-particles experiencing abrasive contact with machine parts and other carrier particles. These fragments, which generally cannot be reclaimed from the developer mixture, have an adverse effect on the triboelectric charging characteristics of the carrier particles, thereby yielding images with lower resolution in comparison to those compositions wherein the carrier coatings are retained on the surface of the core substrate.

The present invention obviates the problems noted above by providing a development system having a magnetic developer material that features novel coated carrier particles. In embodiments of the present invention, the coated carrier particles incorporate a coating of sufficiently resilient characteristic so as to maintain the encapsulation of the respective carrier core while withstanding the aforementioned mechanical action of the skiving blade which would otherwise cause fragmentation of the carrier particles. The consideration of “sufficiently resilient characteristic” is meant herein as the carrier particles coating being sufficient to maintain encapsulation of the carrier core, or fragments thereof, even after being subject to the mechanical action of the developer material stripping device, thus substantially preventing dispersion of carrier core fragments in the event of such fracturing or fragmentation of the carrier core. Preferably, the carrier coating is of a sufficiently thick and/or a resilient nature such that the desired encapsulation is maintained. Resulting benefits include: developer material life and machine operating latitude are extended, development efficiency and image quality is improved, and abrasion at components, such as a skiving device, is reduced.

An apparatus for non-interactive, dry powder development of electrostatic images includes: an image bearing member bearing an electrostatic image; two-component developer comprising toner and permanently magnetized carrier beads, a magnetic developer roll including a stationary magnet, a magnetic core having multiple pole segments, and a cylindrical developer transporting sleeve enclosing and rotating about the magnetic core and the stationary magnet; wherein the magnetic core is located along the interior surface of the sleeve for both agitating and transporting a developer layer of said two component developer, the agitated portion of the layer being spaced close to and not contacting with said image bearing member, and wherein the said developer layer is transported proximate to and within a development zone, where it is subject to the field gradients provided by the multipole magnetic core. Accordingly, the magnetic core is disposed within the sleeve and in close proximity to the development zone, and rotated relative to the sleeve so as to sweep magnetic poles across its surface.

In another feature of the invention, an imaging system for providing image-on-image, non-interactive development of electrostatic images may be constructed to include an image bearing member bearing an electrostatic image; a housing containing developer material, and a magnetic developer roll for transporting the developer material from the housing to the image.

A detailed description of the exemplary embodiments may now be understood with reference to the Figures. Although the present invention will now be described in connection with one or more embodiments, such description is not intended to be so limited. On the contrary, it is intended to cover all alternatives, modifications, and equivalents as may be included within the spirit and scope of the invention as defined by the appended claims. In the following description, usage of like reference numerals will designate identical elements. Disclosure of U.S. Pat. No. 5,946,534; entitled, “APPARATUS AND METHOD FOR NON-INTERACTIVE ELECTROPHOTOGRAPHIC DEVELOPMENT” is hereby incorporated by reference.

FIG. 1 is a partial side view of a prior art development system.

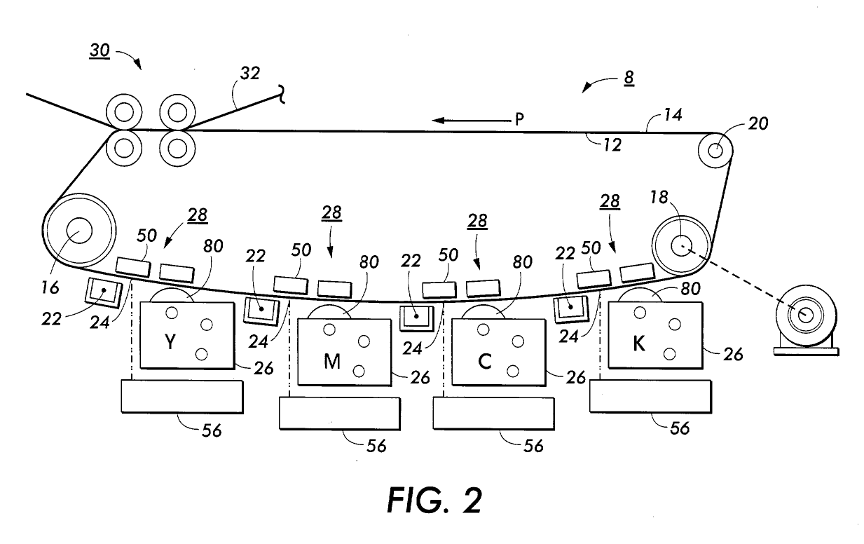

FIG. 2 is a side view, in section, of a four color xerographic reproduction machine incorporating the development system of the present invention.

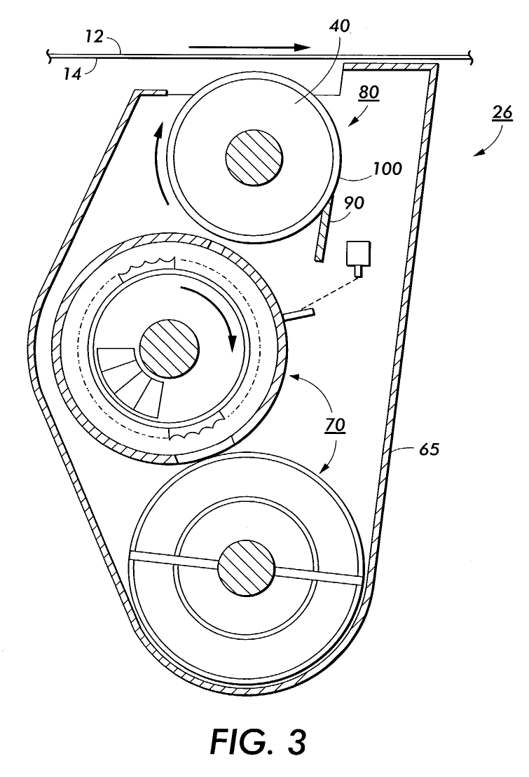

FIG. 3 is an enlarged side sectional view of the development system shown in FIG. 2.

Referring to FIGS. 2 and 3 of the drawings, there is shown a xerographic type reproduction machine 8 incorporating an embodiment of the development system of the present invention that includes a magnetic developer roll designated generally by the numeral 80. Machine 8 has a suitable frame (not shown) on which the machine xerographic components are operatively supported. As will be familiar to those skilled in the art, the machine xerographic components include a recording member, shown here in the form of a translatable photoreceptor 12. In the exemplary arrangement shown, photoreceptor 12 comprises a belt having a photoconductive surface 14. The belt is driven by means of a motorized linkage along a path defined by rollers 16, 18 and 20, and those of transfer assembly 30, the direction of movement being counter-clockwise as viewed in FIG. 2 and indicated by the arrow marked P. Operatively disposed about the periphery of photoreceptor 12 are charge corotrons 22 for placing a uniform charge on the photoconductive surface 14 of photoreceptor 12; exposure stations 24 where the uniformly charged photoconductive surface 14 constrained by positioning shoes 50 is exposed in patterns representing the various color separations of the document being generated; development stations 28 where the electrostatic image created on photoconductive surface 14 is developed by toners of the appropriate color; and transfer and detack corotrons (not shown) for assisting transfer of the developed image to a suitable copy substrate material such as a copy sheet 32 brought forward in timed relation with the developed image on photoconductive surface 14 at image transfer station 30. In preparation for the next imaging cycle, unwanted residual toner is removed from the belt surface at a cleaning station (not shown). Following transfer, the sheet 32 is carried forward to a fusing station (not shown) where the toner image is fixed by pressure or thermal fusing methods familiar to those practicing the electrophotographic art. After fusing, the copy sheet 32 is discharged to an output tray.

At each exposure station 24, photoreceptor 12 is guided over a positioning shoe 50 so that the photoconductive surface 14 is constrained to coincide with the plane of optimum exposure. A raster output scanner (ROS) 56 generates a closely spaced raster of scan lines on photoconductive surface 14 as photoreceptor 12 advances at a constant velocity over shoe 50. At each exposure station 24, a ROS 56 exposes the charged photoconductive surface 14 point by point to generate the electrostatic image associated with the color separation to be generated. It will be understood by those familiar with the art that alternative exposure systems for generating the electrostatic images, such as print bars based on liquid crystal light valves and light emitting diodes (LEDs), and other equivalent optical arrangements could be used in place of the ROS systems such that the charged surface may be imagewise discharged to form an electrostatic image of the appropriate color separation at each exposure station.

Developer assembly 26 includes a developer housing 65 in which a toner dispensing cartridge (not shown) is rotatably mounted so as to dispense toner particles downward into a sump area occupied by the auger mixing and delivery assembly 70 as taught in U.S. Pat. No. 4,690,096 to Hacknauer et al which is hereby incorporated by reference.

Continuing with the description of operation at each developing station 28, the magnetic developer roll 80 is disposed in predetermined operative relation to the photoconductive surface 14 of photoreceptor 12, the length of magnetic developer roll 80 being equal to or slightly greater than the width of photoconductive surface 14, with the central longitudinal axis of magnetic developer roll 80 being parallel to the photoconductive surface and oriented at a right angle with respect to the path of photoreceptor 12. Advancement of magnetic developer roll 80 carries the developer blanket into the development zone in proximal relation with the photoconductive surface 14 of photoreceptor 12 to develop the electrostatic image therein. A suitable controller is provided for operating the various components of machine 8 in predetermined relation with one another to produce full color images containing Y, M, C, K colored toner.

Further details of the construction and operation of the magnetic developer roll 80 of the present invention are now described. The magnetic developer roll 80 includes a rotatable sleeve 100 and magnetic core assembly 40. The magnetic core assembly 40 includes multiple magnetic core pole segments provided in the form of permanent magnets bonded to a cylindrical core of iron or other soft magnet material. Magnets contain regions of alternating magnetic polarization (“N” or “5”) and are preferably arranged to create a multipole structure. Sleeve 100 and magnetic core assembly 40 are made to rotate relative to one another about a common longitudinal axis by suitable mechanical means. Preferably sleeve 100 is also rotated by these means relative to developer housing 65. The relative motion of sleeve 100 and magnet assembly 40 generate a rotating magnetic drive field (not shown) in a reference frame fixed to the surface of sleeve 100. A thin layer of developer material (not shown in FIGS. 2-3) is held on the surface of sleeve 100 and proximate with photoconductor 12 by the gradient in the magnetic field generated in magnets 120. The developer layer includes toner-bearing carrier beads.

In a principal feature of the present invention, the magnetic core assembly 40 utilizes a magnetic developer material that features coated carrier particles which include a coating exhibiting a resilient characteristic so as to maintain the encapsulation of the carrier core while withstanding the aforementioned mechanical action of the skiving blade that would otherwise cause fragmentation of the carrier particles. Materials and methods for producing coated carrier particles are known in the art, and for example, with reference to U.S. Pat. No. 5,744,275, the disclosure of which is incorporated herein by reference, preferred carrier particle coatings include a polymer or a mixture of polymers of sufficient thickness and/or resilient characteristic, and especially a polymer mixture including polyurethane. The various suitable solid core carrier materials can be selected for the magnetic developer of the present invention, also as disclosed in, for example, U.S. Pat. No. 5,744,275. Also, the carrier coating can have incorporated therein various known charge enhancing additives.

The development system described herein is useful for interactive and non-interactive development, depending on whether toner already on the image may or may not be disturbed or removed by subsequent development procedures. Sometimes the terms “scavenging” and “non-scavenging” are used interchangeably with the terms “interactive” and “non-interactive”. Non-interactive development is most useful in color systems when a given color toner must be deposited on an electrostatic image without disturbing previously applied toner deposits of a different color, or cross-contaminating the color toner supplies.

The terms “reprographic” or “reproduction” apparatus, “printing” or “printer”, as used herein, broadly encompasses various printers, copiers or multifunction machines or systems, electrographic and electrostatographic or otherwise, unless otherwise defined in a claim. The term “sheet” herein refers to a generally planar segment of paper, plastic, or other suitable physical substrate amenable to receiving a developed image, whether precut or web fed. A “copy sheet” may be abbreviated as a “copy” or called a “hardcopy”.

As to specific components of the subject apparatus or methods, or alternatives therefor, it will be appreciated that such components are optional if so designated, and if such components are known per se in other apparatus or applications, other versions may be additionally or alternatively used, especially those from art cited herein. All references cited in this specification, and their references, are incorporated by reference herein where appropriate for teachings of additional or alternative details, features, and/or technical background.

What is claimed is:

1. A composition of coated carrier particles for use in a developer material employed in a development system for developing an image, the development system including a magnetic developer roll for transporting the developer material and mechanical means for separating the developer material from the magnetic developer roll, the coated carrier particles being comprised of a core material and thereover a coating, wherein the coating exhibits a resilient characteristic sufficient to maintain the encapsulation of the respective carrier core while withstanding the mechanical separation of the developer material from the magnetic developer roll.

2. The composition of coated carrier particles of claim 1, wherein the coating further comprises a polymer exhibiting a resilient characteristic.

3. The composition of coated carrier particles of claim 2, wherein the polymer further comprises a polyurethane.

4. The composition of coated carrier particles of claim 1, wherein the coating further comprises a polymer of sufficient thickness to exhibit the requisite resilient characteristic.

5. The composition of coated carrier particles of claim 1, wherein the core material further comprises permanently magnetized carrier beads.

6. A development system for developing an image with developer material, comprising:
a housing containing the developer material; and
a magnetic developer roll for transporting the developer material from the housing to the image, the magnetic developer roll including a magnetic core assembly and a sleeve enclosing the magnetic core, wherein at least one of the sleeve and magnetic core assembly being rotatable for providing relative rotation, and wherein the magnetic core assembly includes a plurality of magnets arranged with respect to the central longitudinal axis of the magnetic developer roll; and
mechanical means for separating the developer material from the magnetic developer roll;
wherein the developer material includes coated carrier particles each having a core material and thereover a coating, wherein the coating exhibits a resilient characteristic sufficient to maintain the encapsulation of the respective carrier core while withstanding the mechanical separation of the developer material from the magnetic developer roll.

7. The development system of claim 6, wherein the coating further comprises a polymer exhibiting a resilient characteristic.

8. The development system of claim 7, wherein the polymer further comprises a polyurethane.

9. The development system of claim 6, wherein the coating further comprises a polymer of sufficient thickness to exhibit the requisite resilient characteristic.

10. The development system of claim 6, wherein the core material further comprises permanently magnetized carrier beads.
